(19) United States
(12) Patent Application Publication
(10) Pub. No.: US 2006/0075100 A1
(43) Pub. Date: Apr. 6, 2006

(54) System, device, software and method for providing enhanced UPnP support on devices

(75) Inventor: Vlad Stirbu, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/951,522

(22) Filed: Sep. 28, 2004

(51) Int. Cl. G06F 15/173

(52) U.S. Cl. 709/225

(57) ABSTRACT

A system, device, software and method for providing enhanced UPnP support on constrained devices. A low power proxy is used to save and communicate information with other devices on a local area network. The low power proxy can aggregate information for transmission to the constrained device in various situations, aiding the constrained device in receiving requested and necessary information in the event that information is filtered before reaching the constrained device and/or in the event that the constrained device is in a “low power” mode.

### BACKGROUND OF THE INVENTION

The present invention relates generally to the field of terminal architecture. More particularly, the present invention relates to terminal architecture when implementing Universal Plug and Play (UPnP) protocol on limited devices having energy constraints.

Network architectures, such as UPnP systems, have become increasingly popular in recent years. UPnP networks are used to connect and permit communication between a wide variety of electronic devices, including but not limited to desktop and laptop computers, portable and cellular telephones, computer printers, monitors, stereos, personal digital assistants, video game devices and other products. When a device is within the coverage of such a home network, it is capable of communicating with any other devices that are within the network. This allows for the sharing of a wide variety of types of information.

UPnP technology defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking in addition to control and data transfer among networked devices.

A Mobile/Handheld Network (MHN) is formed by all devices that by their nature are constrained by power supply, processing power or bearer capabilities. Mobile handheld devices (MH) such as mobile phones, PDAs or laptop computers running on batteries may be considered constrained devices. These devices can use Bluetooth, LAN or Wireless LAN as bearers.

A home network (HN) is formed by devices that, during normal operation, are attached to an AC power supply. Usually these devices possess good computing power, implementing the required functionality in software or hardware. Consumer electronics (i.e. networked TV sets, networked stereo systems and PVRs) and computers (i.e. desktop computers, laptop computers plugged into docking station) are considered home network devices.

A network connectivity function (NCF) is the logical function that links home networks and mobile/handheld networks together. In addition to the basic bridge functionality, the network connectivity function can implement additional services like UPnP Filtering. UPnP filtering is implemented in the network connectivity function and involves the snooping the IP traffic and blocking UPnP multicast messages generated in the home network from reaching the Mobile/Handheld Network.

UPnP Device Architecture is designed to support zero-configuration, “invisible” networking, and automatic discovery for a breadth of device categories from a wide range of vendors. This permits a device to dynamically join a network, obtain an IP address, convey its capabilities, and learn about the presence and capabilities of other devices. UPnP device architecture defines the steps that must be followed by a device in order to participate in the UPnP network. The UPnP phases or steps in a stand alone UPnP device are depicted generally in FIG. 1, with the initial steps being shown at the bottom of the Figure. The first three steps—addressing, discovery and description, must be followed in this strict order. During this step-by-step procedure, a device obtains an IP address from a Dynamic host configuration protocol (DHCP) server or using an auto-IP procedure, learns about the other UPnP devices present in the network, and fetches XML description document. After these three steps are completed, a control point (CP) has all the information needed to start using the respective service/device. The remaining steps (i.e. control, eventing and presentation) don't have such strict rules and can be performed in any order.

UPnP Device Architecture can be implemented in a wide range of devices. Some of these devices are more suited than others to support the networking technologies employed in UPnP Device Architecture. For devices such as mobile phones or PDAs that are battery powered and used for connectivity wireless technology, the UPnP Device Architecture is much more than is actually required for the respective mobile devices. The high amount of network traffic and the pattern of this traffic drains the battery very quickly, adversely affecting the overall user experience.

One of the main limitations of the UPnP Device Architecture v1.0 is that, during the design phase, the designers did not consider the special requirements of constrained, mobile devices that have definite energy reserves. This makes it difficult to run UPnP v1.0 based services on mobile devices, such as mobile phones, because the UPnP protocols will drain the battery very quickly. Furthermore, the UPnP theory of operations does not allow devices to go to sleep, as it assumes by default the UPnP devices are always online. From a power saving point of view, the discovery and description steps depicted in FIG. 1 pose the largest issues for a constrained device. Due to the multicast nature of discovery messages and the traffic pattern, a constrained device is unable to switch to a low power state, resulting in the battery being drained very quickly. On the description side, description files are often very large and will tend to consume the entire bandwidth for certain time intervals on slower links such as Bluetooth. Similar problems can also occur with nonmobile devices that, due to regulatory requirements, need to conserve energy on a regular basis, such as Energystar compliant consumer electronics.

The above-identified problems and others were previously recognized and some steps have been taken to reduce the network traffic in UPnP DA v1.1. For example, a number of potential improvements have been discussed in Finland Patent Application No. 20040179, filed on Feb. 6, 2004 and incorporated herein by reference. However, these steps were not sufficient to solve the particular problems with mobile devices because the steps reduced only the network traffic but not the traffic pattern. For example, under this system UPnP control points in the home network still are not capable of searching for UPnP root/embedded devices and services available on the mobile handheld network. Furthermore, UPnP root/embedded devices and services are not able to advertise themselves to UPnP control points available on the mobile handheld network. Both of these limitations have an impact on how the user of a mobile device perceives the UPnP network, making it different than for a user on a home network device. For example, there might be delays as long as ten to fifteen minutes between the moment a new device appears in the home network and the moment the device is discovered.

### SUMMARY OF THE INVENTION

The present invention addresses the above-identified issues by enabling a constrained UPnP device to fully maintain its presence in the UPnP network while at the same time conserving power. The present invention involves the delegating of the discovery and description steps of the UPnP device architecture to another device that does not have the power constraints of the constrained device, while maintaining the remaining functionality of the constrained device.

The present invention involves the use of a low power proxy (LPP) that acts as an aggregator of the root/embedded devices and services for mobile handheld network and home network mechanisms by which the low power proxy interacts with mobile handheld network devices and home network devices. The present invention can also be applied to other nonmobile devices that are designed to save energy. The present invention also extends the functionality of the UPnP simple service discovery protocol (SSDP) and UPnP generic event and notification architecture (GENA) by adding new meanings to existing header fields.

The present invention is directed to the method in which the network infrastructure device with low power proxy interacts with the other UPnP entities in the network. The present invention involves the addition of two new variables to the network infrastructure device in order to add the low power proxy functionality to the existing network infrastructure device functionality. The present invention also adds a new field in the device/service description, with the new field containing a pointer to the network infrastructure device with low power proxy that handles the respective device or service. The present invention also discloses a generic system and method that allows a device to wake up a constrained device in a bearer-independent manner.

The present invention possess a number of significant advantages over the prior art. For example, but without limitation, the present invention provides a generic UPnP solution that works with any existing UPnP profiles. The system is also “backward compatible”, meaning that UPnP DA v1.0 and v1.1 devices work without modifications with devices implementing the present invention. The present invention also enables home network devices to advertise to mobile handheld network control points and home network control points to query mobile handheld network devices, thus rectifying the limitation that exists in the prior art. The present invention additionally enables UPnP discovery between two mobile handheld network devices and also creates a lightweight solution to existing issues, while also saving power consumption and resulting in faster discovery in the UPnP environment. The present invention can be incorporated into virtually any mobile phone having UPnP/(digital home working group (DHWG) support.

Furthermore, the present invention takes advantage of the existing services provided by network infrastructure device and the work done for IGDv2. The invention does not require changes to UPnP Device Architecture other than the ones required by the IGDv2 (which have already been provided by UPnP v1.1), and the design is modular as the functionality required is implemented as a service.

### BRIEF DESCRIPTION OF THE DRAWINGS

FIG. 1 is a representation of the UPnP phases involved in a stand alone UPnP device;

FIG. 2 is a representation of the UPnP phases involved in a UPnP device and a UPnP low power proxy;

FIG. 3 is a representation of the network architecture elements in a system including a low power proxy built into a network connectivity function according to one embodiment of the present invention;

FIG. 4 is a representation of the stack for the network connectivity function of FIG. 3;

FIG. 5 is a representation of the network architecture elements in a system including a stand alone low power proxy according to an alternative embodiment of the present invention;

FIG. 6 is a representation of the stack for the network connectivity function and low power proxy of FIG. 5;

FIG. 7 is a representation of the stack for the network connectivity function and low power proxy for an alternative embodiment of the invention;

FIG. 8 is a representation showing the aggregation of various devices and services according to one embodiment of the present invention;

FIG. 9 is a representation showing various responses to home network control point queries;

FIG. 10 is a representation showing a mobile device control point expressing interest after a home network device becomes available;

FIG. 11 is a representation showing a mobile device control point expressing interest before a home network device becomes available;

FIG. 12 is a representation showing the disappearance of a home network device without sending an “ssdp: byebye” signal;

FIG. 13 is a representation showing the disappearance of a home network device while sending an “ssdp: byebye” signal; and

FIG. 14 is a representation of a generic low power proxy device according to the principles of the present invention.

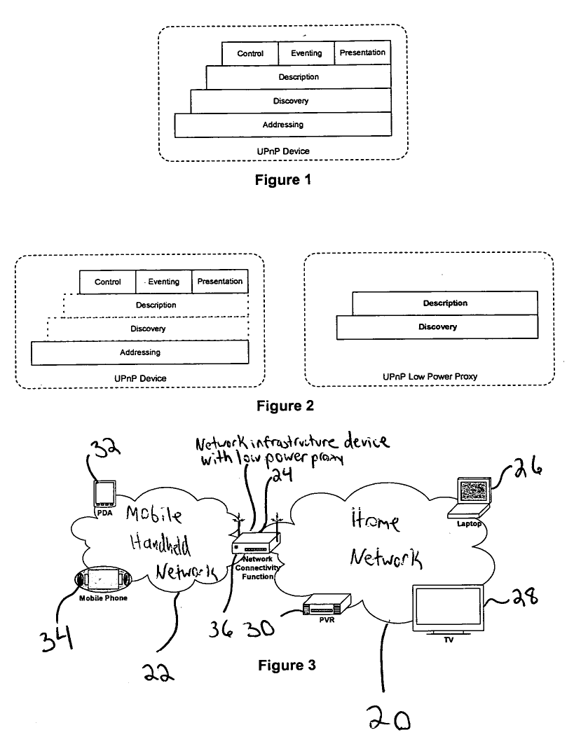

### DETAILED DESCRIPTION OF THE PREFERRED EMBODIMENTS

The present invention involves delegating the discovery and description steps of the architecture of a mobile device or another form of a constrained device to another device, referred to herein as a low power proxy, that does not have the power constraints of the constrained device, while maintaining the remaining functionality of the constrained device.

A low power proxy is a UPnP service that aggregates the information about root/embedded devices and services from the mobile device Network and makes it available in the home network. At the same time, the low power proxy provides methods for the mobile devices to “register” for particular root/embedded devices and services available in home network and informs the mobile devices when those services becomes available using an energy efficient mechanism. The low power proxy is a new element in the network architecture.

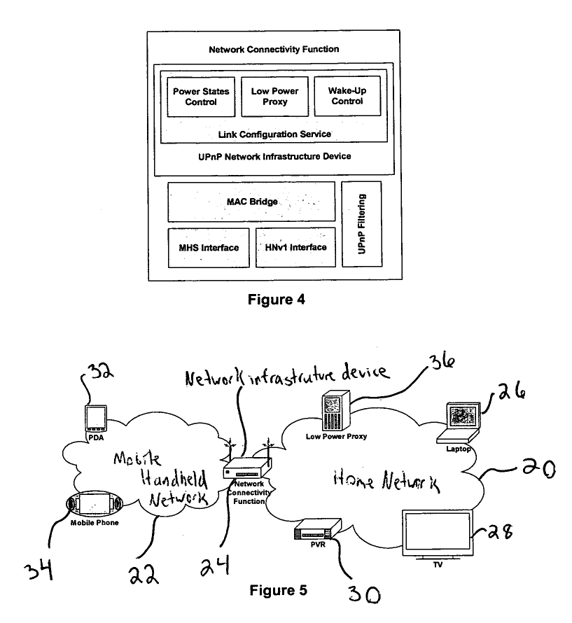

In an exemplary embodiment of the present invention, a low power proxy is built into a network infrastructure device that also implements the network connectivity function. The network architecture elements according to this embodiment are shown in FIG. 3. FIG. 3 shows a home network 20 and a mobile handheld network 22 interconnected by a network infrastructure device 24. In the embodiment shown in FIG. 3, the home network 20 includes home network devices such as a laptop computer 26, a television, 28 and a personal video recorder 30. The mobile handheld network 22 includes mobile handheld network devices such as a personal digital assistant 32 and a mobile telephone 34. Additional devices can be included in either the home network 20 and the mobile handheld network 22. It should be understood, that, although mobile handheld devices and/or networks are discussed herein, the present invention is application to virtually type of device having energy constraints (also referred to as constrained device.) A low power proxy 36 is built into the network infrastructure device 24. As represented in FIG. 14, the low power proxy 36 includes a memory unit 40 for storing computer code, a processor 42 for processing information, including computer code stored in the memory unit 40 and computer code transmitted from other devices, and at least one data communication link 44 for communicating with devices the home network 20 and the mobile handheld network 22. The data communication link 44 can take a variety of wired or wireless forms, including, but not limited to, BlueTooth and WLAN links. Multiple data communication links 44 can also be used. The network connectivity function stack of the relevant elements for this particular embodiment of the invention is shown in FIG. 4.

Conventionally, the wireless local area network access point and the Bluetooth Access Point configuration services contains a state variable named associatedDevice that keeps information about the MAC Address, the IP Address and authentication state. There is one associatedDevice structure for each device that is associated with the network infrastructure device. The following is an example of this structure for a wireless LAN Access Point:

<xs:element name=“associatedDevice” minOccurs=“0” maxOccurs=“32”>

<xs:complexType>

<xs:sequence>

<xs:element name=“deviceMACAddress” type=“internet
gateway

device_v2:macAddress” />

<xs:element name=“deviceIPAddress” type=“internet
gateway

device_v2:ipAddress” />

<xs:element name=“deviceAuthenticationState”
type=“xs:boolean” />

</xs:sequence>

</xs:complexType>

</xs:element>

In order to add the power states control functionality to the network infrastructure device, a state variable is added as an element of the associatedDevice. The devicePowerState variable keeps track of the power state of the link. According to one embodiment of the invention, four values for devicePowerState could be used: “on”, “light sleep”, “deep sleep” and “off”. Each bearer has its own specific link configuration service and that enables a network infrastructure device to map the specific characteristics of the bearer to the four possible states. Because this variable is part of the associatedDevice, the network infrastructure device can maintain the power state for each individual associated device. The power state control functionality is not dependent upon the number of available power states and allows the addition of additional power states in order to enhance the functionality of the system.

In order to add the low power proxy functionality to the network infrastructure device, another state variable is required as an element of the associatedDevice. This second state variable is named deviceLowPowerProxy. This state variable is a placeholder that includes all the information needed to proxy the devices/services and control points hosted by the associated device.

The structure of the associatedDevice in a network infrastructure device with low power proxy incorporating the above variables is as follows:

<xs:element name=“associatedDevice” minOccurs=“0” maxOccurs=“7”>

<xs:complexType>

<xs:sequence>

<xs:element name=“deviceBDAddress” />
<xs:element name=“deviceIPAddress” />
<xs:element name=“deviceAuthenticationState” />
<xs:element name=“devicePowerState” />
<xs:element name=“deviceLowPowerProxy”
minOccurs=“0”>

<xs:complexType>

<xs:sequence>

<xs:element name=“cpProxy”
minOccurs=“0” maxOccurs=“unbounded” />
<xs:element name=“deviceProxy”
minOccurs=“0” maxOccurs=“unbounded”

/>

</xs:sequence>

</xs:complexType>

</xs:element>

</xs:sequence>

</xs:complexType>

</xs:element>

It should be noted that, although the power states control and low power proxy functions are identified herein as distinct functional events, their operation is closely linked to each other. For example, changes in the power states control immediately triggers the low power proxy to take the appropriate action in order to reflect the change in the proxied device.

A constrained device that requires a low power proxy can also include an additional element in the description XML document that points to the low power proxy:
<lowPowerProxyURL>URL for low power proxy</lowPowerProxyURL>

A control point that does not support the low-power functionality will ignore this element and will continue functioning without taking advantage of the low-power features.

The theory of operation of the system described above is generally as follows, using a situation where there exists a Bluetooth device that hosts a UPnP service. When this device joins the network, it contacts a Bluetooth access point (or access device) in order to establish an association with the access point and to gain access to the network. When the association is established, the network infrastructure device with low power proxy has all the relevant information related to the attached device in an associatedDevice state variable.

The next step in the process is to actually initiate the UPnP service. The first phase in this process is to discover which network infrastructure device is the one to which the device is attached. The Internet gateway device, version 2 (IGDv2) includes extension headers to the simple service discovery protocol that allows the device to discover the particular network infrastructure device. In this case, the device will search for a network infrastructure device that has an association with a device that has its own MAC/IP address. Only one network infrastructure device will respond to this query. The UPnP device/service therefore discovers which is its network infrastructure device that will play also the role of the low power proxy.

When a device has discovered its network infrastructure device with low power proxy functionality, the device can start feeding the appropriate information (i.e. device universal unique identifier (UUID), device description) into the deviceLowPowerProxy state variable of the respective network infrastructure device. When a control point has discovered its network infrastructure device with low power proxy functionality, it can start feeding the appropriate information (i.e. devices of interest) into the deviceLowPowerProxy state variable of the respective network infrastructure device. The low power proxy handles both discovery and description on behalf of the device.

When the device is in an active state, the device would handle the discovery function itself and would delegate the description function to the low power proxy. In this situation, an announcement would be transmitted in a form such as is shown below:
HTTP/1.1 200 OK
CACHE-CONTROL: max-age=seconds until advertisement expires
LOCATION: URL for UPnP description for root device cached in low power proxy
SERVER: OS/version UPnP/1.0 product/version
ST: search target
NTS: ssdp:alive
SERVER: OS/version UPnP/1.0 product/version
USN: advertisement UUID

When the device is in a deeper sleep mode and the low power proxy is handling both the discovery and the description functions, the announcement is sent by the low power proxy itself.

When a control point has discovered a network infrastructure device with low power proxy functionality, it can begin transmitting the appropriate information, such as device of interest, into the deviceLowPowerProxy state variable of the respective network infrastructure device. When relevant services appear in the network, the low power proxy informs the control point by transmitting a unicast advertisement, which may be formatted as follows:
NOTIFY*HTTP/1.1
CACHE-CONTROL: max-age=−1
NT: search target
NTS: ssdp:alive
SERVER: OS/version UPnP/1.0 product/version
USN: advertisement UUID

The meaning of the “CACHE-CONTROL: max-age=−1” is that the advertisement never expires. The low power proxy takes care to inform the control point when the correspondent device or service leaves the network. Alternatively the low power proxy can inform the control point that a device/service of interest appeared in the network by sending an event. Regardless of the method that is used, the low power proxy must send only one announcement per service-constrained control point tuple.

When an UPnP device/service has discovered its network infrastructure device, the device/service can include a pointer to this low power proxy in the device description. Interested control points can subscribe to the low power proxy to receive events when the devicePowerState is changing. In this way, the control points have the latest information about the power state of the devices that are relevant to their operation. Additionally, by having a pointer to the low power proxy of the device, a control point can change the power state of a device (i.e. wake up the device) in an independent way, without having to be concerned with the particularities of the specific bearer of the device. To accomplish this task, the control point asks the low power proxy to wake the device, and the proxy performs the task. For example, in a situation where there is a Bluetooth constrained device that is sleeping and a control point (which can be from a home network device or a mobile handheld network device) that is aware of the lower-power proxy that is handling the constrained device, if the control point desires to wake up the constrained device, it will send a UPnP SOAP message (a wake up instruction to the lower power proxy with the constrained device's universal unique identifier). The low power proxy knows that the device that has the specified universal unique identifier in the wake-up message is a Bluetooth device with a Bluetooth device address “BD_ADDR” and will initiate the Bluetooth-specific wake-up mechanism (i.e., a Bluetooth search for the device BD-ADDR, initiate the Bluetooth PAN with the device BD_ADDR.

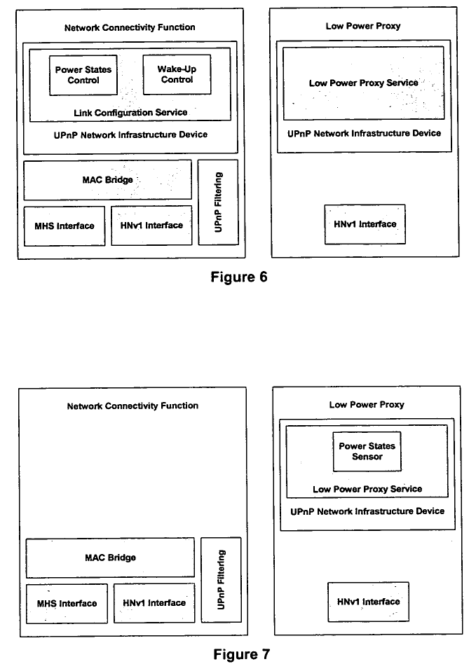

In an alternate embodiment of the invention, a stand alone low power proxy is used instead of a built in low power proxy. The network architecture elements for such a system are shown in FIG. 5, with a stand-alone lower power proxy 36. The network connectivity function stack and the low power proxy stack are shown in FIG. 6. FIG. 7 shows the network connectivity function stack and the low power proxy stack for yet another embodiment of the present invention.

The deployment system for the embodiment of the invention shown in FIGS. 5 and 6 is similar to a system including a built-in lower power proxy except that the low power proxy is a stand alone device and the functionality is implemented in the low power proxy service that is part of a network infrastructure device. The low power proxy must subscribe to the network connectivity function in order to receive events regarding the changes in power states of the attached devices.

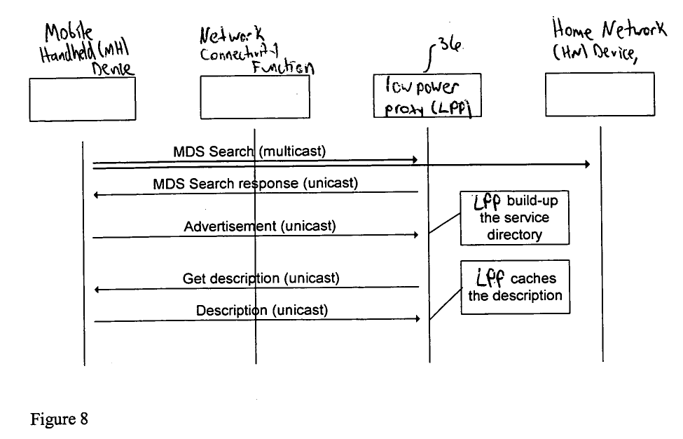

FIGS. 8-13 show a system by which the low power proxy can be used to aggregate information from the various devices on the network, as well as transmit information to the devices. The low power proxy is a discoverable service in the UPnP network. The low power proxy listens to the UPnP advertisements and collects information. With this information, the low power proxy creates a directory with root/embedded devices and services. As the low power proxy is a discoverable service in the UPnP network, mobile devices can also discover the low power proxy. These mobile devices use unicast advertisements to advertise their root/embedded devices and services to the low power proxy. As shown in FIG. 8, when the low power proxy receives a unicast advertisement from a mobile device, the low power proxy connects to the device and downloads the XML device description and adds it to the directory.

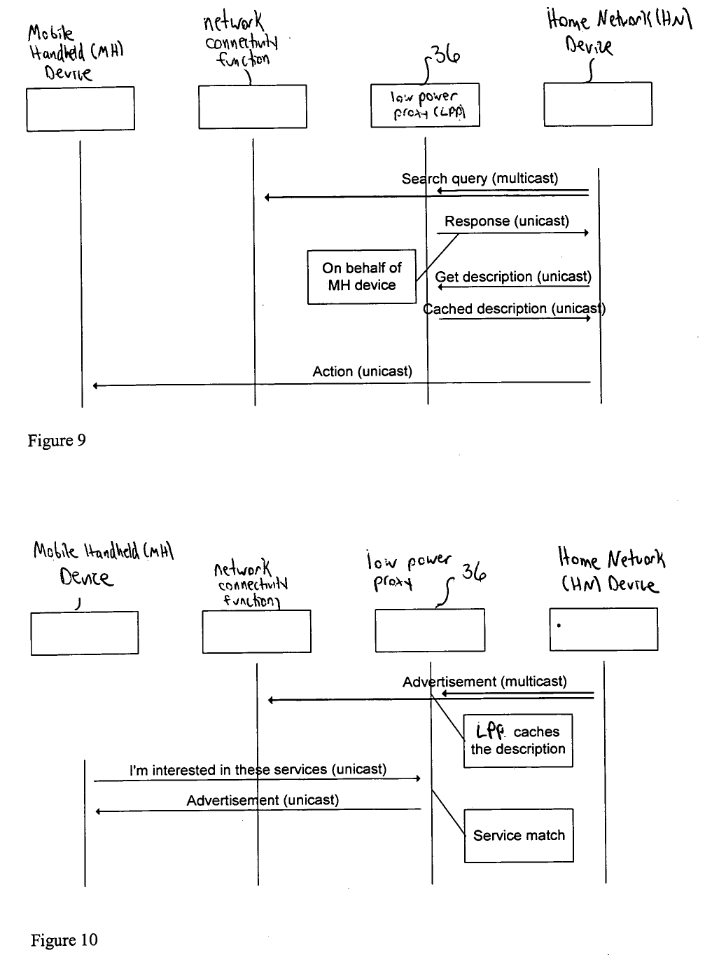

In some situations, multicast search queries from home network control points do not reach the mobile devices because the network connectivity function is filtering the UPnP multicast messages. In this situation, the low power proxy acts on behalf of the mobile device and sends a response to the search query. This process is represented in FIG. 9. For example, the response may be formatted as follows:
HTTP/1.1 200 OK
CACHE-CONTROL: max-age=seconds until advertisement expires
DATE: when response was generated
EXT:
LOCATION: URL for UPnP cached description for root device
SERVER: OS/version UPnP/1.0 product/version
ST: search target
USN: advertisement UUID

All of the information contained in this message is similar with the information received in the original message except the LOCATION header is replaced with a URL to the local cached XML device description. It is important to note that the low power proxy does not change the universal unique identifier. Instead, the low power proxy preserves the universal unique identifier of the original device.

FIG. 9 shows the process by which the low power proxy responds to a home network control point query. When the low power proxy receives a unicast message from a mobile device, it will multicast in the home network. The multicast advertisement header LOCATION will point to the local cached XML description.

Registration of services of interest can be achieved using an enhanced eventing service. A mobile device control point has to renew its subscriptions and unsubscribe when it leaves the network. The low power proxy maintains the status of each mobile device control point based on eventing subscriptions, renewals and unsubscriptions. When a device representing control point fails to renew its subscription or unsubscribe, it means that it has left the network and the low power proxy will clean up the association with the respective control point. Alternatively, this functionality can be implemented by extending generic event and notification architecture; however, enhanced eventing is a preferred method of implementation. The mobile device control point registers its “services of interest” to the low power proxy and there is no need for further simple service discovery protocol queries.

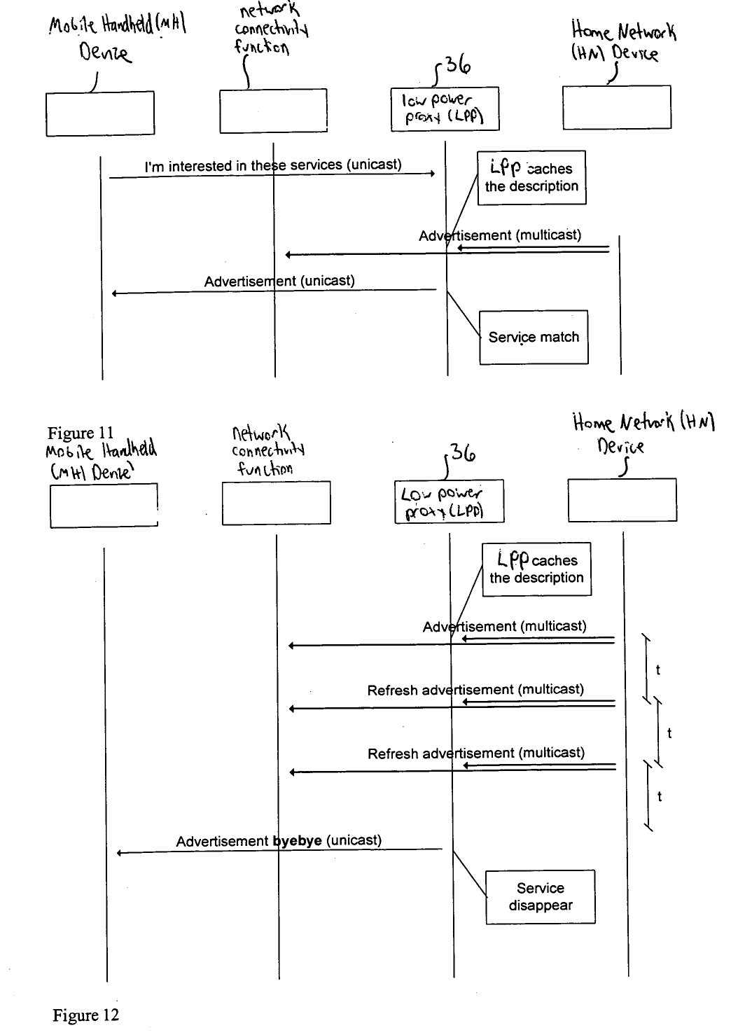

Device and service advertisements generated in the home network are often not able to reach mobile device control points because the network connectivity function is filtering the UPnP multicast messages. The low power proxy compensates for this limitation. As described above, the low power proxy listens to all UPnP multicast messages. The low power proxy collects this information and stores it in a directory. Additionally, mobile device control points can register their interest for specific services. This process is represented in FIG. 10, for situations after a home network device is available, and in FIG. 11, for situations before a home network device is available.

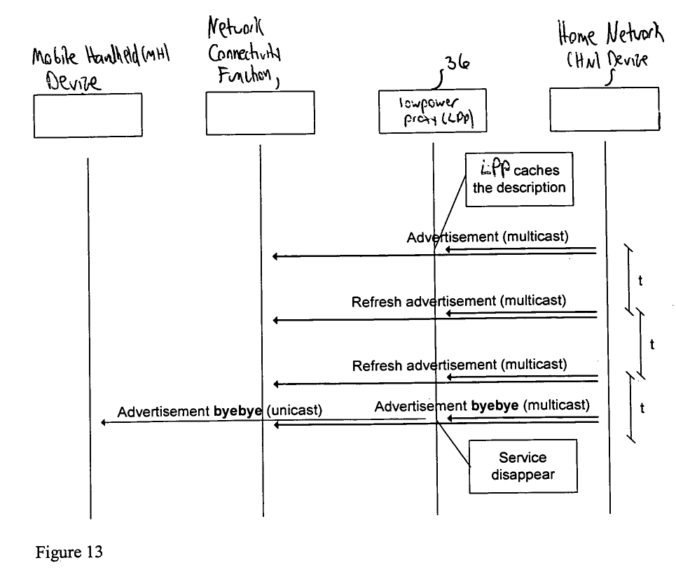

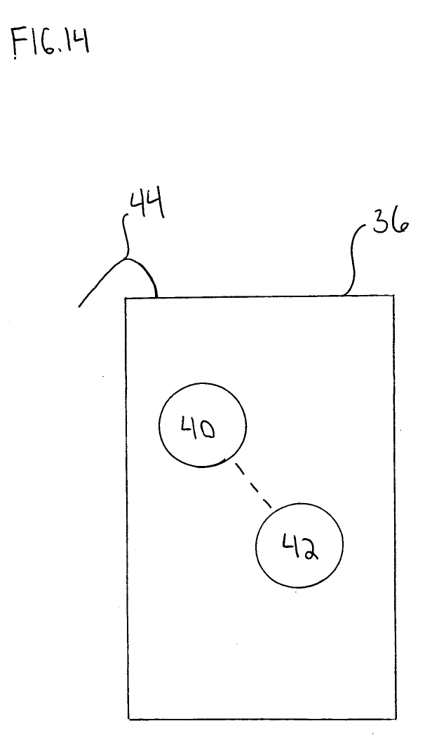

When a home network device “gracefully” leaves the network by sending an “ssdp: byebye”, represented in FIG. 13, or fails to refresh its advertisements, represented in FIG. 12, the low power proxy sends a unicast advertisement to the corresponding mobile device control point, informing the mobile device control point that the home network device has left the UPnP network.

The low power proxy described herein can be used in conjunction with a new field and new variables to add to the existing network infrastructure device functionality and the low power proxy functionality, such as the systems represented in FIGS. 3 and 5.

While preferred embodiments have been shown and described herein, it should be understood that changes and modifications can be made to the invention without departing from the invention in its broader aspects. For example, but without limitation, the individual devices within the network can use a wide variety of connection mechanisms, such as implementing wireless LAN (WLAN)/Bluetooth access points, as well as Ethernet switches to serve as contact points. Various features of the invention are defined in the following Claims.

1. A local area network system, comprising:
a home network device operatively connected to a home network;
a constrained device;
a low power proxy for arranging data transmission between the home network device and the constrained device.

2. The local area network system of claim 1, wherein the low power proxy permits the constrained device to register for devices and services offered by the home network, and wherein the low power proxy informs the constrained device when the registered for devices and services become available.

3. The local area network system of claim 1, wherein, in the event that an advertisement from the home network is not made available to the constrained device, the low power proxy collects the advertisement for transmission to the constrained device.

4. The local area network system of claim 1, wherein, in the event that a multicast search query from the home network is not made available to the constrained device, the low power proxy collects the multicast search query and provides a response on behalf of the constrained device.

5. The local area network system of claim 1, wherein, when the home network device informs the low power proxy that the home network device is exiting the home network, the low power proxy informs the constrained device that the home network device is exiting the home network.

6. The local area network system of claim 1, wherein, when the home network device fails to refresh advertisements to the low power proxy over a designated time interval, the low power proxy informs the constrained device that the home network device has exited the home network.

7. The local area network system of claim 1, wherein the home network is a universal plug and play network.

8. The local area network system of claim 1, wherein at least one of the home network device and the constrained device possess a wireless LAN contact point.

9. The local area network system of claim 1, wherein at least one of the home network device and the constrained device possess a Bluetooth contact point.

10. The local area network system of claim 1, wherein the low power proxy is built into a network connectivity function.

11. The local area network system of claim 1, wherein the low power proxy is a separate device from a network connectivity function.

12. The local area network system of claim 1, wherein the constrained device transmits a message to the low power proxy requesting that the low power proxy serve as a low power proxy for the constrained device.

13. The local area network system of claim 12, wherein the constrained device transmits information to the low power proxy concerning the degree to which the low power proxy needs to function as a low power proxy.

14. The local area network system of claim 12, wherein the constrained device transmits information to the low power proxy concerning changes in state to the mobile network service.

15. The local area network system of claim 1, wherein at least one of the home network device and the constrained device possess an Ethernet contact point.

16. The local area network system of claim 1, wherein the low power proxy is configured to transmit a wake up message to the constrained device at the request of another device within the local area network system.

17. A method of arranging data transmission within a network system, comprising the steps of:
providing a home network including a home network device
providing a constrained device network including a constrained device
enabling a network infrastructure device to interact with the home network device and the constrained device; and
using a low power proxy device operatively connected to the network infrastructure device to arrange data transmission between the home network device and the constrained device.

18. The method of claim 17, wherein the low power proxy device is built into the network infrastructure device.

19. The method of claim 17, wherein the low power proxy device is a stand alone device separate from the network infrastructure device.

20. The method of claim 17, further comprising the step of transmitting a message from the constrained device to the low power proxy device requesting that the low power proxy device serve as a low power proxy for the constrained device.

21. The method of claim 17, further comprising the step of transmitting a message from the constrained device to the low power proxy device concerning the degree to which the low power proxy device needs to function as a low power proxy for the constrained device.

22. The method of claim 17, further comprising the step of transmitting information to the low power proxy from the constrained device concerning changes in state to the constrained device.

23. The method of claim 17, wherein at least one of the home network device and the constrained device possess a wireless LAN contact point.

24. The method of claim 17, wherein at least one of the home network device and the constrained device possess a Bluetooth contact point.

25. The method of claim 17, wherein at least one of the home network device and the constrained device possess an Ethernet contact point.

26. The method of claim 17, further comprising the step of transmitting a wake up message to the at least one constrained device at the request of another device within either the home network or the constrained device network.

27. A low power proxy device, comprising:
a memory unit;
a processor for processing information stored in the memory unit; and
at least one data communication link for communicating with a home network device and a constrained device within a local area network,
wherein the low power proxy device uses the at least one data communication link to enable data transmission between the home network device and the constrained device.

28. The low power proxy device of claim 27, wherein the low power proxy device is built into a network infrastructure device.

29. The low power proxy device of claim 27, wherein the low power proxy device is a stand alone device separate from but operatively connected to the network infrastructure device.

30. The low power proxy device of claim 27, wherein the low power proxy device is configured to receive requests that the low power proxy device serve as a low power proxy for the constrained device.

31. The low power proxy device of claim 27, wherein the low power proxy device is configured to receive information from the constrained device concerning the degree to which the low power proxy device needs to function as a low power proxy.

32. The low power proxy device of claim 27, wherein the low power proxy device is configured to receive information from the constrained device concerning changes in state to the mobile network service.

33. The low power proxy device of claim 27, wherein the low power proxy device is configured to transmit a wake up message to the at least one constrained device at the request of another device within either the local area network or the mobile handheld network.

34. A computer program product, comprising:
computer code for enabling a low power proxy device to communicate with a constrained device; and
computer code for at the request of the constrained device, causing the low power proxy device to function as a low power proxy for the constrained device.

35. The computer program product of claim 34, further comprising computer code for receiving information from the constrained device concerning the degree to which the low power proxy needs to function as a low power proxy for the constrained device.

36. The computer program product of claim 34, further comprising computer code for transmitting a wake up message to the constrained device at the request of another device within a local area network.

37. The computer program product of claim 34, further comprising computer code for receiving information from the constrained device concerning changes in state to the mobile network service.
